(19) United States
(12) Patent Application Publication
(10) Pub. No.: US 2020/0372368 A1
(43) Pub. Date: Nov. 26, 2020

(54) APPARATUS AND METHOD FOR SEMI-SUPERVISED LEARNING

(71) Applicant: SAMSUNG SDS CO., LTD., Seoul (KR)

(72) Inventors: Jong-Won CHOI, Seoul (KR); Young-Joon CHOI, Seoul (KR); Ji-Hoon KIM, Seoul (KR); Byoung-Jip KIM, Seoul (KR)

(21) Appl. No.: 16/782,320

(22) Filed: Feb. 5, 2020

Related U.S. Application Data
(60) Provisional application No. 62/853,078, filed on May 27, 2019.

(30) Foreign Application Priority Data
May 23, 2019 (KR) 10-2019-0060501

(51) Int. Cl. G06N 3/08; G06N 3/04

(52) U.S. Cl. CPC G06N 3/088; G06N 3/0454

(57) ABSTRACT

A semi-supervised learning apparatus includes a backbone network configured to extract one or more feature values from input data, and a plurality of autoencoders as many of which are provided as the number of classes to be classified of the input data, wherein each of the plurality of autoencoders is assigned any one class of the classes to be classified as a target class and learns the one or more feature values according to whether the class, with which the input data is labeled, is identical to the target class.

### CROSS-REFERENCE TO RELATED APPLICATION

This application claims the benefit of US Provisional Patent Application No. 62/853,078 filed on May 27, 2019 and the benefit of Korean Patent Application No. 10-2019-0060501, filed on May 23, 2019, the disclosures of which are incorporated herein by reference for all purposes.

### BACKGROUND

### 1. Field

Embodiments of the present disclosure relate to a technique for semi-supervised learning using a partially labeled dataset.

### 2. Discussion of Related Art

Supervised learning is a method of machine learning to infer one function from training data. In order to improve performance of supervised learning, a learning process using a large training dataset is essential. However, training data requires a process of directly classifying and labeling data by humans and a huge cost is incurred due to this process. Therefore, there is a need for a method of improving performance of machine learning by utilizing pieces of unlabeled data which are remaining even when only some pieces of data of an entire dataset are labeled.

### SUMMARY

Embodiments of the present disclosure are intended to provide a technical means for improving performance of supervised learning by utilizing pieces of unlabeled data which are remaining even when only some pieces of data of an entire dataset are labeled.

According to an aspect of the present disclosure, there is a semi-supervised learning apparatus including a backbone network configured to extract one or more feature values from input data, and a plurality of autoencoders as many of which are provided as the number of classes to be classified of the input data. Each of the plurality of autoencoders is assigned any one class of the classes to be classified as a target class and learns the one or more feature values according to whether the class, with which the input data is labeled, is identical to the target class.

The autoencoder may include an encoder learned so as to receive the one or more feature values and output different encoding values according to whether the labeled class is identical to the target class, and a decoder learned so as to receive the encoding value and output the same value as the feature value input to the encoder.

The encoder may be learned so that an absolute value of the encoding value approaches zero when the labeled class is identical to the target class and so that the absolute value of the encoding value becomes farther from zero when the labeled class is different from the target class.

When the labeled class is not present in the input data, a plurality of encoders provided in each of the plurality of autoencoders may be learned so that marginal entropy loss of encoding values output from the plurality of encoders is minimized.

The semi-supervised learning apparatus may further include a predictor configured to, when test data is input to the backbone network, compare sizes of encoding values output from a plurality of encoders provided in each of the plurality of autoencoders and determine a target class corresponding to a smallest encoding value as a class to which the test data belongs as a result of the comparison.

According to another aspect of the present disclosure, there is a semi-supervised learning method comprising extracting, by a backbone network, one or more feature values from input data, and assigning any one class of the classes to be classified as a target class and learning, by a plurality of autoencoders as many of which are provided as the number of classes to be classified of the input data, the one or more feature values according to whether the class, with which the input data is labeled, is identical to the target class.

The learning of the one or more feature values may include encoding, by an encoder, of learning so as to receive the one or more feature values and output different encoding values according to whether the labeled class is identical to the target class, and decoding, by a decoder, of learning so as to receive the encoding value and output the same value as the feature value input to the encoder.

The encoder may be learned so that an absolute value of the encoding value approaches zero when the labeled class is identical to the target class and so that the absolute value of the encoding value becomes farther from zero when the labeled class is different from the target class.

When the labeled class is not present in the input data, a plurality of encoders provided in each of the plurality of autoencoders may be learned so that marginal entropy loss of encoding values output from the plurality of encoders is minimized.

The method may further comprise, when test data is input to the backbone network, comparing, by a predictor, sizes of encoding values output from a plurality of encoders provided in each of the plurality of autoencoders, and determining, by the predictor, a target class corresponding to a smallest encoding value as a class to which the test data belongs as a result of the comparison.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram for describing a semi-supervised learning apparatus (100) according to an embodiment;

FIG. 2 is a block diagram for describing a detailed configuration of an autoencoder (104) according to an embodiment;

FIG. 3 is a graph of output values of an encoder (202) according to an embodiment expressed by visualizing;

FIG. 4 is a diagram illustrating an example in which test data is input to a semi-supervised learning apparatus (100) which is learned according to an embodiment;

FIG. 5 is a diagram illustrating an example in which an autoencoder (104) is added in a semi-supervised learning apparatus (100) according to an embodiment;

FIG. 6 is a diagram illustrating an example in which an autoencoder (104) is divided in a semi-supervised learning apparatus (100) according to an embodiment; FIG. 7 is a flowchart for describing a semi-supervised learning method (700) according to an embodiment; and

FIG. 8 is a block diagram for illustrating and describing a computing environment (10) that includes a computing device appropriate for use in exemplary embodiments.

### DETAILED DESCRIPTION

Hereinafter, embodiments of the present disclosure will be described in detail with reference to the accompanying drawings. The following detailed description is provided to assist the reader in gaining a comprehensive understanding of the methods, apparatuses, and/or systems described herein. However, the description is only exemplary, and the present disclosure is not limited thereto.

In describing embodiments of the present disclosure, when it is determined that a detailed description of known techniques associated with the present disclosure would unnecessarily obscure the subject matter of the present disclosure, the detailed description thereof will be omitted. Also, terms used herein are defined in consideration of the functions of the present disclosure and may be changed depending on a user, the intent of an operator, or a custom. Accordingly, the terms should be defined based on the following overall description of this specification. The terminology used herein is only for the purpose of describing embodiments of the present disclosure and is not restrictive. The singular forms “a,” “an,” and “the” are intended to include the plural forms as well, unless the context clearly indicates otherwise. It should be understood that the terms “comprises,” “comprising,” “includes,” and/or “including,” specify the presence of stated features, integers, steps, operations, elements, components, and/or groups thereof when used herein but do not preclude the presence or addition of one or more other features, integers, steps, operations, elements, components, and/or groups thereof.

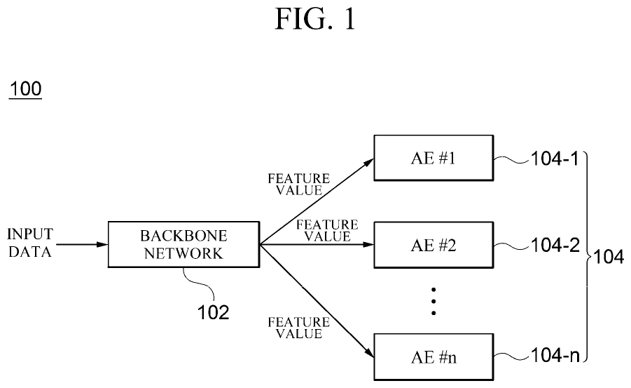

FIG. 1 is a block diagram for describing a semi-supervised learning apparatus 100 according to an embodiment. The semi-supervised learning apparatus 100 according to the embodiment is an apparatus for performing semi-supervised learning using learning data of which only some pieces of data are labeled and predicting a classification value of test data using a result of the learning. As illustrated in the drawing, the semi-supervised learning apparatus 100 according to the embodiment includes a backbone network 102 and a plurality of autoencoders 104.

The backbone network 102 extracts one or more feature (input feature) values from input data. In embodiments of the present disclosure, the backbone network 102 may extract the feature values from the input data according to a type and a feature of the input data using various feature extraction models. For example, when the input data is an image, the backbone network 102 may include one or more convolution layers and a pooling layer. However, this is exemplary, and the backbone network 102 may use an appropriate feature extraction model as necessary and is not limited to a specific feature extraction model.

As many autoencoders 104 are provided as the number of classes of the input data to be classified. For example, when the number of target classes to be classified from the input data is three, the number of autoencoders 104 is also three. Any one class of the classes to be classified is assigned to each of the plurality of autoencoders 104 as a target class. For example, when the classes to be classified include three classes, class #1, class #2, and class #3, class #1 may be assigned as a target class of a first autoencoder 104-1, class #2 may be assigned as a target class of a second autoencoder 104-2, and class #3 may be assigned as a target class of a third autoencoder 104-3. Each of the autoencoders 104 receives the feature values of the input data from the backbone network 102 and learns the one or more feature values according to whether a class, with which the input data is labeled, is identical to a target class assigned to itself.

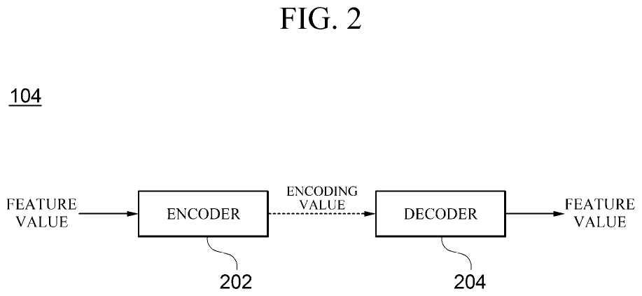

FIG. 2 is a block diagram for describing a detailed configuration of the autoencoder 104 according to the embodiment. As illustrated in the drawing, the autoencoder 104 according to the embodiment includes an encoder 202 and a decoder 204.

The encoder 202 is a part which performs learning so as to receive the feature value of the input data output from the backbone network 102 and output different encoding values according to whether the class, with which the input data is labeled, is identical to the target class assigned to the autoencoder 104.

The decoder 204 is a part which performs learning so as to receive the encoding value from the encoder 202 and output the same value as the feature value which is input to the encoder 202. That is, the decoder 204 is learned so that a result (the feature value of the input data) obtained from the backbone network 102 is output without changing.

The encoder 202 and the decoder 204 may be configured to perform learning using various machine learning models as necessary. Specifically, when the feature value of the input data is given, a method in which each autoencoder 104 is learned is as follows.

First, a method of learning the labeled data, that is, data having information about the class to be classified to which the corresponding data belongs, will be described. In the case in which the feature value of the input data labeled with the class to be classified is input, the encoder 202 is learned so that an absolute value of the encoding value approaches zero when the class, with which the input data is labeled, is identical to the target class assigned to itself, and conversely, so that the absolute value of the encoding value becomes farther from zero when the labeled class is different from the target class. In other words, according to whether the class of the input data is identical to the target class of the current autoencoder 104, the encoder 202 and the decoder 204 perform learning as follows.

A. In the case in which the class of the input data is identical to the target class of the current autoencoder 104,

an absolute value of an output value (encoding value) of the encoder 202 is located near zero (approaches zero or converges to zero), and

an output value of the decoder 204 is identical to an input value of the encoder 202.

B. In the case in which the class of the input data is different from the target class of the current autoencoder 104,

an absolute value of an output value (encoding value) of the encoder 202 is located as far as possible from zero, and

an output value of the decoder 204 is identical to an input value of the encoder 202.

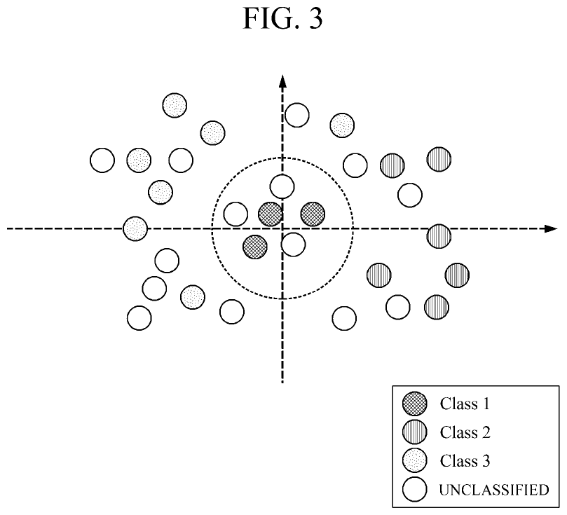

FIG. 3 is a graph of the output values of the encoder 202 according to the embodiment expressed by visualizing. The graph shows an example in which the target class assigned to the autoencoder 104 to which the encoder 202 belongs is class #1. In addition, two axes constituting the graph represent elements of the encoding value output to the encoder 202. In the illustrated embodiment, it is assumed that the encoding values are shown on a two-dimensional plane, but this is exemplary and the dimension of the encoding values may be appropriately determined in consideration of features of the input data.

As illustrated in FIG. 3, when the target class of the encoder 202 is class #1, the encoder 202 may be learned so that an absolute value of an encoding value of input data belonging to class #1 approaches zero (i.e., so as to be located in a dotted circle) and that an absolute value of an encoding value of input data not belonging to class #1 becomes farther from zero (i.e., so as to be located outside the dotted circle).

First, a method of learning unlabeled data, that is, data not having information about the class to be classified to which the corresponding data belongs, will be described. When there is no class with which the input data is labeled, the plurality of encoders 202 included in each of the plurality of autoencoders 104 may be learned so that marginal entropy loss of the encoding values output from the plurality of encoders 202 is minimized. A more detailed description thereof will be given as follows.

It cannot be known which class the unlabeled input data, that is, corresponding data for the unclassified input data, corresponds to. Therefore, it is impossible to selectively learn a specific autoencoder 104 using the unlabeled data. However, even in this case, it is clear that the corresponding data corresponds to any one of the plurality of classes. Therefore, in this case, each of the autoencoders 104 performs learning on each encoder 202 so that only a result of one encoder of the plurality of encoders 202 approaches zero and results of the remaining encoders are farther from zero due to marginal entropy loss of the encoding values output from the plurality of encoders 202 being minimized using the marginal entropy loss. That is, when the unclassified input data is given, a method in which each of the autoencoders 104 is learned is as follows.

C. In the case in which there is no class of the input data

an encoding value is derived to approach zero for only one of the plurality of encoders 202 by minimizing the marginal entropy loss of the encoding values output from the encoders 202.

an output value of the decoder 204 is identical to an input value of the encoder 202.

In the embodiments of the present disclosure, it is assumed that a vector having distances between the encoding values of the encoders 202 and zero as elements is a vector V. In this case, it is possible to define a probability vector P whose probability value decreases as the distances, which are the elements of the vector V, increase. A point at which the marginal entropy loss of the probability vector P is minimized is a place at which a probability value of only one specific element of the probability vector P is one and probability values of all the remaining elements are zero. In this case, in the vector V, the probability value of only one specific element thereof is very close to zero and the probability values of the remaining elements become farther from zero. When the unclassified input data is given, each of the autoencoders 104 may be learned so that the encoding value approaches zero for only one of the plurality of encoders 202 by minimizing the marginal entropy loss of the output encoding values using the vector V.

In the embodiments of the present disclosure, each of the autoencoders 104 is learned so that the encoder 202 compresses the input information and then the decoder 204 outputs the same result as the input information. Therefore, when the input information is similar, the information compressed by the encoder is also similar. As a result, in the case of the data for which the class is not present, it will be learned to output the encoding value which is closest to zero in the autoencoder 104 learned in the most similar class. Through this process, the unclassified data may be used for learning. Each autoencoder 104 may perform learning using various types of loss functions.

Examples of the loss functions may include Euclidean distance, binary entropy, marginal entropy, and the like.

For example, the loss function in the case in which each autoencoder 104 is learned using Euclidean distance may be configured as follows.

It is assumed that classes of current input data are defined as c ∈ {1, . . . , N_{c}} and target classes of each autoencoder are defined as cₜ ∈ {1, . . . , N_{c}}. In addition, it is assumed that the encoder 202 and the decoder 204 in the autoencoder 104 whose target class is ct are defined as f_{c}_{ₜ}(·) and g_{c}_{ₜ}(·), respectively. That is, when a feature value of the current input data, which is output from the backbone network 102, is v, f_{c}_{ₜ}(v) denotes a feature vector of an encoding value output from the encoder 202 and g_{c}_{ₜ}(f_{c}_{ₜ}(v)) denotes a result value which has passed through both of the encoder 202 and the decoder 204. Since the autoencoder 104 should be learned for each class, the number of classes of the input data is identical to the number of target classes of the autoencoder 104. In such a structure, the probability that specific data belongs to the class cₜ is expressed by Equation 1 below.

$$p ( v \vert {c}_{t} ) = \frac{exp ( - {f}_{{c}_{t}} ( ν ) )}{{\sum }_{c = 1}^{{N}_{c}} exp ( - {f}_{c} ( v ) )} \qquad [ Equation 1 ]$$

That is, according to Equation 1 above, the probability of the corresponding class increases as the result of the encoder is close to zero. Based on the above Equation, the above-described learning method may be calculated as follows.

A. If (c═cₜ) (in the case in which the class of the input data is identical to the target class of the current autoencoder 104),

an absolute value of an output value (L1) of the encoder 202 is located near zero (approaches zero or converges to zero), and

L₁=∥f_{c}_{ₜ}(v)∥²

an output value (L2) of the decoder 204 is identical to an input value of the encoder 202.

L₂=∥v−g_{c}_{ₜ}(f_{c}_{ₜ}(v))∥².

B. If (c≠cₜ) (in the case in which the class of the input data is different from the target class of the current autoencoder 104),

an absolute value of an output value (L1) of the encoder 202 is located as far as possible from zero

L₁=−∥f_{c}_{ₜ}(v)∥², and

an output value (L2) of the decoder 204 is identical to an input value of the encoder 202

L₂=∥v−g_{c}_{ₜ}(f_{c}_{ₜ}(v))∥².

C. If (c is unknown) (in the case in which there is no class of the input data),

an encoding value (L3) is derived to approach zero for only one of the plurality of encoders 202 using the marginal entropy loss.

L₃=Σ_{c}_{ₜ}₌₁^{N}^{_{c}} −p(v|cₜ)log p(v|cₜ), and

an output value (L2) of the decoder 204 is identical to an input value of the encoder 202.

L₂=∥v−g_{c}_{ₜ}(f_{c}_{ₜ}(f_{c}_{ₜ}(v))∥²,

As a result, only when the class of the input data is identical to the target class, it is learned so that the encoding value (the compressed value of the feature value of the backbone network 102) of the encoder 202 of the autoencoder 104 is close to zero. At the same time, each autoencoder 104 is learned so that the same result as the input value is output, and accordingly, the encoder 202 is learned so that the similarity of the result of the encoder 202 is to be similar to the similarity of the input feature value. In addition, by minimizing information dispersion through the marginal entropy loss, the unclassified data has a high probability value for only one class.

Meanwhile, the semi-supervised learning apparatus 100 according to the embodiment may further include a predictor (not illustrated). In an embodiment, when the test data is input to the backbone network 102, the predictor may compare sizes of the encoding values output from the plurality of encoders 202 included in each of the plurality of autoencoders 104 and determine a target class corresponding to a smallest encoding value as a class to which the test data belongs as a result of the comparison.

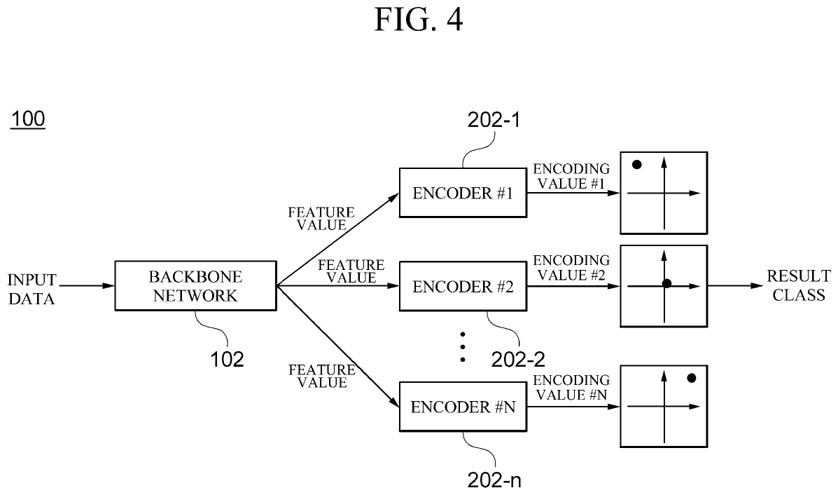

FIG. 4 is a diagram illustrating an example in which test data is input to a semi-supervised learning apparatus 100 which is learned according to an embodiment. When test data is input to the semi-supervised learning apparatus 100, a backbone network 102 extracts one or more feature values from the test data by the same process as learning data. Thereafter, encoders 202 included in each of the plurality of autoencoders 104 output encoding values from feature values of the input test data. Then, the predictor compares sizes of the encoding values output from the encoders 202 and determines a target class corresponding to a smallest encoding value as a class to which the test data belongs as a result of the comparison. In the embodiment illustrated in FIG. 4, it can be seen that a size of an absolute value of the encoding value output from an encoder #2 202-2 among the plurality of encoders 202 is the smallest. Therefore, in this case, a result class of the test data is class #2.

In the embodiments of the present disclosure, the encoders 202 of each autoencoder 104 are learned so that a value close to zero is output for pieces of data corresponding to the target class. Therefore, even in the case of the test data, results of the encoders 202 may be compared and the target class of the autoencoder 104 whose result is closest to zero may be output as a final result. A decoder 204 does not perform any role in the testing operation.

The reliability of the semi-supervised learning apparatus 100 having the above-described structure is as follows. As described above, the semi-supervised learning apparatus 100 determines the class of the autoencoder 104 which outputs the encoding value closest to zero as the class of the corresponding test data when the test data is input. However, even when the output value of the encoder 202 is the value closest to zero, the corresponding test data is most likely not used for actual learning when the output value is relatively far from zero as compared to other learning data. Accordingly, the reliability of the result of the specific test data may be calculated using Equation 2 below.

$$Reliability ( v ) = exp ( - {min}_{{c}_{t}} {‖ {f}_{{c}_{t}} ( v ) ‖}^{2} ) \qquad [ Equation 2 ]$$

That is, according to the above equation, when a value closest to zero among result values output from the encoder is zero, the maximum reliability, one, may be obtained, and when the value becomes farther from zero, the reliability may be gradually reduced.

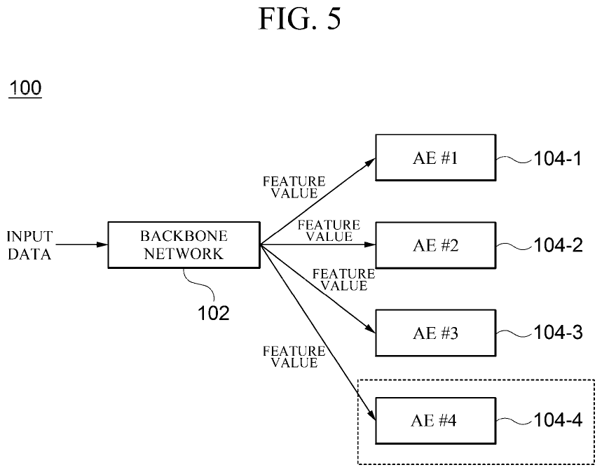

FIG. 5 is a diagram illustrating an example in which an autoencoder 104 is added in a semi-supervised learning apparatus 100 according to an embodiment. The illustrated embodiment shows an example in which an autoencoder #4 104-4, which is a new autoencoder, is added after model learning using an autoencoder #1 104-1, an autoencoder #2 104-2, and an autoencoder #3 104-3 is completed. In a general supervised learning model, when a new class is intended to be added after model learning is completed, the existing model should newly perform learning in consideration of all the data from the beginning. However, in the semi-supervised learning apparatus 100 according to the embodiment of the present disclosure, learning needs to be performed only on a new autoencoder 104-4. In this case, learning for the newly added autoencoder 104-4 may be performed as follows.

In the case in which a class of input data is identical to a target class of the added autoencoder 104-4,

an absolute value of an output value (encoding value) of the encoder 202 is located near zero (approaches zero or converges to zero), and

an output value of the decoder 204 is identical to an input value of the encoder 202.

In the case in which a class of input data is different from a target class of the added autoencoder 104-4,

an absolute value of an output value (encoding value) of the encoder 202 is located as far as possible from zero, and

an output value of the decoder 204 is identical to an input value of the encoder 202.

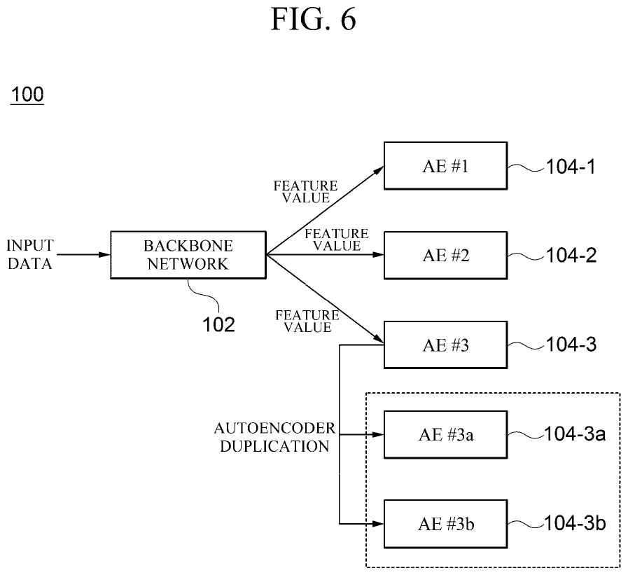

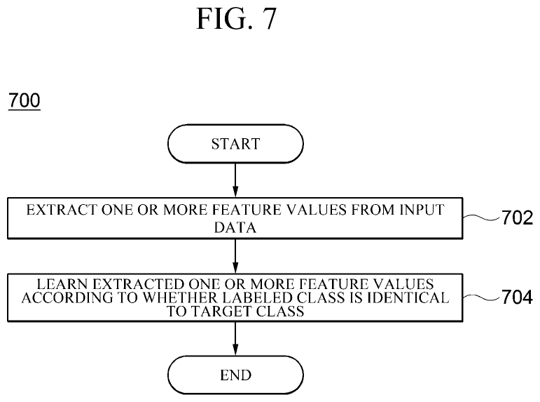

FIG. 6 is a diagram illustrating an example in which an autoencoder 104 is divided in a semi-supervised learning apparatus 100 according to an embodiment. The illustrated embodiment shows an example in which an autoencoder #3 104-3 is divided into an autoencoder #3a 104-3a and an autoencoder #3b 104-3b after model learning using an autoencoder #1 104-1, an autoencoder #2 104-2, and an autoencoder #3 104-3 is completed. When a specific class that has been learned after the model learning has been completed is intended to be divided into two or more classes, the existing model should newly perform learning in consideration of all the data from the beginning. However, the semi-supervised learning apparatus 100 according to the embodiment of the present disclosure merely needs to duplicate the autoencoder 104-3 of a class which is simply divided, and learn only the duplicated autoencoder 104-3 (104-3a or 104-3b). The duplicated autoencoder 104-3 (104-3a or 104-3b) may be easily learned using only data belonging to the corresponding class divided by the following learning method.

In the case in which a class of input data is identical to a target class of the divided autoencoder 104-3 (104-3a or 104-3b),

an absolute value of an output value (encoding value) of the encoder 202 is located near zero (approaches zero or converges to zero), and

an output value of the decoder 204 is identical to an input value of the encoder 202.

In the case in which the class of the input data is different from the target class of the divided autoencoder 104-3 (104-3a or 104-3b),

an absolute value of an output value (encoding value) of the encoder 202 is located as far as possible from zero, and

an output value of the decoder 204 is identical to an input value of the encoder 202.

FIG. 7 is a flowchart for describing a semi-supervised learning method 700 according to an embodiment. The illustrated flowchart may be performed by a computing device, for example, the semi-supervised learning apparatus 100 described above, including one or more processors and a memory configured to store one or more programs executed by the one or more processors. In the illustrated flowchart, the method or process is described as being divided into a plurality of operations. However, at least some operations may be performed in reverse order, may be performed in combination with another operation, may be omitted, may be performed by being subdivided into sub-operations, or may be performed by adding one or more operations which are not illustrated.

In operation 702, a backbone network 102 extracts one or more feature values from input data.

In operation 704, any one of classes to be classified is assigned to a target class of each of a plurality of autoencoders 104 and each of the plurality of autoencoders 104 learns the one or more feature values according to whether the class, with which the input data is labeled, is identical to the target class. Specifically, the encoder 202 is learned so as to receive the one or more feature values from the backbone network 102 and output different encoding values according to whether the labeled class is identical to the target class, and the decoder 204 performs learning so as to receive the encoding value and output the same value as the feature value input to the encoder.

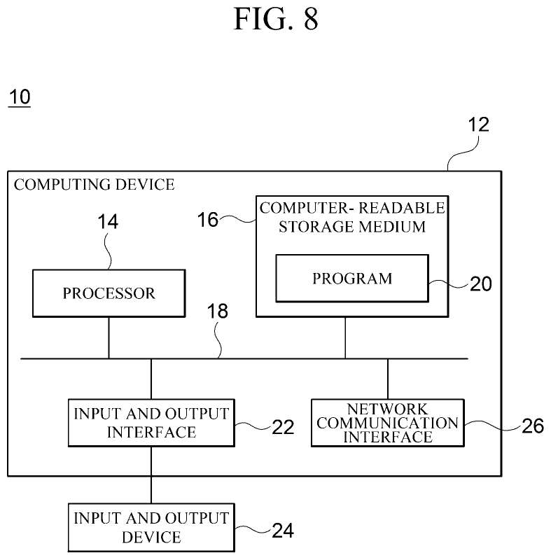

FIG. 8 is a block diagram for illustrating and describing a computing environment 10 that includes a computing device appropriate for use in exemplary embodiments. In the illustrated embodiment, components may have different functions and capabilities in addition to those described below, and additional components in addition to those described below may be provided.

The illustrated computing environment 10 includes a computing device 12. In an embodiment, the computing device 12 may be a semi-supervised learning apparatus 100 according to the embodiments of the present disclosure. The computing device 12 includes at least one processor 14, a computer-readable storage medium 16, and a communication bus 18. The processor 14 may allow the computing device 12 to operate according to the exemplary embodiments described above. For example, the processor 14 may execute one or more programs stored in the computer-readable storage medium 16. The one or more programs may include one or more computer executable instructions, and the computer executable instructions may be configured to allow the computing device 12 to perform the operations according to the exemplary embodiments when being executed by the processor 14.

The computer-readable storage medium 16 is configured to store computer executable instructions and program codes, program data, and/or other appropriate forms of information. A program 20 stored in the computer-readable storage medium 16 includes a set of instructions executable by the processor 14. In an embodiment, the computer-readable storage medium 16 may include memories (volatile memories such as random access memories (RAMs), non-volatile memories, or combinations thereof), one or more magnetic disk storage devices, optical disk storage devices, flash memory devices, other types of storage media accessed by the computing device 12 and capable of storing desired information, or appropriate combinations thereof.

The communication bus 18 connects various components of the computing device 12 to each other, including the processor 14 and the computer readable storage-medium 16.

The computing device 12 may further include one or more input and output interfaces 22 for providing an interface for one or more input and output devices 24 and one or more network communication interfaces 26. The input and output interfaces 22 and the network communication interfaces 26 are connected to the communication bus 18. The input and output device 24 may be connected to other components of the computing device 12 through the input and output interfaces 22. For example, the input and output devices 24 may include input devices, such as a pointing device (such as a mouse or trackpad), a keyboard, a touch input device (such as a touchpad or touchscreen), a voice or sound input device, various types of sensor devices, and/or imaging devices, and/or may include output devices, such as display devices, printers, speakers, and/or network cards. For example, the input and output device 24 may be included inside the computing device 12 as one component of the computing device 12 and may be connected to the computing device 12 as a separate device from the computing device 12.

According to the embodiment of the present disclosure, by arranging autoencoders for each class to be classified, even when some pieces of training data are labeled, pieces of unlabeled data which are remaining can be additionally used for learning. That is, according to the embodiments of the present disclosure, it is possible to perform learning in consideration of both of the labeled data and the unlabeled data using the autoencoders which are arranged for each class.

Further, according to the embodiments of the present disclosure, first learning is performed on a backbone network using labeled data and a result value of the backbone network is used as an input of each autoencoder, and thus higher classification performance can be secured as compared to the case of using only a backbone network or autoencoders.

Embodiments of the present disclosure may include a program for executing the method described herein on a computer and a computer-readable recording medium including the program. The computer-readable recording medium may include any one or a combination of program instructions, a local data file, a local data structure, etc. The medium may be designed and configured specifically for the present disclosure or may be generally available in the field of computer software. Examples of the computer-readable recording medium include a magnetic medium, such as a hard disk, a floppy disk, and a magnetic tape, an optical recording medium, such as a compact disc read only memory (CD-ROM) and a digital video disc (DVD), and a hardware device specially configured to store and execute a program instruction, such as a read only memory (ROM), a RAM, and a flash memory. Examples of the program instructions may include machine code generated by a compiler and high-level language code that can be executed in a computer using an interpreter.

Although example embodiments of the present disclosure have been described in detail, it should be understood by those skilled in the art that various changes may be made without departing from the spirit or scope of the present disclosure. Therefore, the scope of the present disclosure is to be determined by the following claims and their equivalents and is not restricted or limited by the foregoing detailed description.

What is claimed is:

1. A semi-supervised learning apparatus comprising:
a backbone network configured to extract one or more feature values from input data; and
a plurality of autoencoders as many of which are provided as the number of classes to be classified of the input data,
wherein each of the plurality of autoencoders is assigned any one class of the classes to be classified as a target class and learns the one or more feature values according to whether the class with which the input data is labeled, is identical to the target class.

2. The semi-supervised learning apparatus of claim 1, wherein the autoencoder includes:
an encoder learned so as to receive the one or more feature values and output different encoding values according to whether the labeled class is identical to the target class; and
a decoder learned so as to receive the encoding value and output the same value as the feature value input to the encoder.

3. The semi-supervised learning apparatus of claim 2, wherein the encoder is learned so that an absolute value of the encoding value approaches zero when the labeled class is identical to the target class and so that the absolute value of the encoding value becomes farther from zero when the labeled class is different from the target class.

4. The semi-supervised learning apparatus of claim 2, wherein, when the labeled class is not present in the input data, a plurality of encoders provided in each of the plurality of autoencoders are learned so that marginal entropy loss of encoding values output from the plurality of encoders is minimized.

5. The semi-supervised learning apparatus of claim 2, further comprising a predictor configured to, when test data is input to the backbone network, compare sizes of encoding values output from a plurality of encoders provided in each of the plurality of autoencoders and determine a target class corresponding to a smallest encoding value as a class to which the test data belongs as a result of the comparison.

6. A semi-supervised learning method comprising:
extracting, by a backbone network, one or more feature values from input data; and
assigning any one class of classes to be classified as a target class and learning, by a plurality of autoencoders as many of which are provided as the number of classes to be classified of the input data, the one or more feature values according to whether the class, with which the input data is labeled, is identical to the target class.

7. The semi-supervised learning method of claim 6, wherein the learning of the one or more feature values includes:
encoding, by an encoder, of learning so as to receive the one or more feature values and output different encoding values according to whether the labeled class is identical to the target class; and
decoding, by a decoder, of learning so as to receive the encoding value and output the same value as the feature value input to the encoder.

8. The semi-supervised learning method of claim 7, wherein the encoder is learned so that an absolute value of the encoding value approaches zero when the labeled class is identical to the target class and that the absolute value of the encoding value becomes farther from zero when the labeled class is different from the target class.

9. The semi-supervised learning method of claim 7, wherein, when the labeled class is not present in the input data, a plurality of encoders provided in each of the plurality of autoencoders are learned so that marginal entropy loss of encoding values output from the plurality of encoders is minimized.

10. The semi-supervised learning method of claim 7, further comprising:
when test data is input to the backbone network, comparing, by a predictor, sizes of encoding values output from a plurality of encoders provided in each of the plurality of autoencoders; and
determining, by the predictor, a target class corresponding to a smallest encoding value as a class to which the test data belongs as a result of the comparison.
